(19) United States
(12) Patent Application Publication
(10) Pub. No.: US 2005/0236233 A1
(43) Pub. Date: Oct. 27, 2005

(54) Lifting and descent apparatus

(76) Inventor: Peter Hamilton Boyle, Queensland (AU)

Correspondence Address: LAURA G. BARROW, P.O. BOX 215, ESTERO, FL, 33928, US

(21) Appl. No.: 10/514,453

(22) PCT Filed: May 14, 2003
(86) PCT No.: PCT/AU03/00570

§ 371 Date: Jun. 13, 2005

(30) Foreign Application Priority Data
May 15, 2002 (AU) PS 2333

(51) Int. Cl. B66B 11/04

(52) U.S. Cl. 187/251

(57) ABSTRACT

A device is described for providing an emergency exit from burning buildings, for installation and/or removal of bulky items from the upper levels of buildings, or for rapid deployment of military and other personnel from helicopters. The device (1) comprises a helical tubular body member (2) comprising three coils of copper tube. The outer ends of the body member (2) are configured such that they form an upper outlet end (3) and a lower outlet end (4) disposed substantially in the same vertical plane. At each upper outlet end (3) and lower outlet end (4) is affixed a respective chuck (5a,b), each chuck (5a, b) comprising an outer internally threaded body (6a, b) which can reversibly operate respective multiple jaws (7) to bear upon a rope (8) which passes through the upper chuck (5a), the coils of the body member (2) and the lower chuck (5b). If the device is to be arrested in use, a locking clamp (15) can be positioned within reach of the user. The clamp (15) comprises a hollow tube (16), hinged (17) longitudinally to allow the tube (16) to be placed around the descent rope (8). A removable pin (18) secures the tube (16) in position around the rope (8). A threaded screw-type adjuster (19) bears upon and frictionally engages the rope (8).

THIS INVENTION relates to lifting and descent apparatus. In particular, it is directed to, but not limited to, an apparatus for providing an emergency exit from burning buildings and the like, or for installation and/or removal of bulky items from the upper levels of buildings, or for rapid deployment of military and other personnel from helicopters or similar.

It has long been recognised that conventional fire rescue equipment such as ladders cannot be fabricated safely to the height required to reach the upper levels of the high-rise buildings which are now commonplace in most major cities. Accordingly, should an outbreak of fire or other disaster occur at these upper levels, the occupants must first make their way to a lower level within the building before they can be rescued. Of course, this may not always be possible leading to loss of life simply because there is no mechanism to reach the occupants trapped at these higher levels.

There have been a number of prior art attempts to provide rescue equipment for these situations, the rescue equipment being stored at the required levels within the building. These prior art attempts include apparatus of the type disclosed in DE142530, DE2429335, DE2602073, DE2637718, DE3301557 and AU653576 all of which incorporate a hollow coiled body member through which a rope is a frictional fit. The upper end of the rope is attached to a suitable point of the building, the body member is secured to the user and, as the person descends, the friction created between the rope and the internal surface of the coil member controls the descent. An inherent disadvantage in these prior art apparatil is the fixed nature of the frictional resistance with no control over the rate of decent which is essentially determined by the choice of materials from which the apparatus is manufactured or by the weight of the person using the device. A heavier weight user is expected to descend faster than a lighter weight user and the user cannot alter that rate.

Yet another attempt is disclosed in AU21723/83 which describes a housing having spooled therein a steel descent tape. The tape is attached to the structure of a building and the housing is attached to the user via a harness. Descent is controlled by an adjustable brake and the heat generated by friction through the brake is dispersed into a coolant dispensed simultaneously with the tape. However, such an apparatus has proven expensive to manufacture and uneconomic to install in large numbers.

Other known related devices are of the abseiling type where a person slides down a tethered rope. A form of controlled descent is possible if the person pushes off from the rock face or side of the building as the momentum returns them to the face or side for pushing off again as the person slides down the rope. This form of device is also often used to deploy military personnel from helicopters which hover close to the ground. However, operation of the abseiling device requires use of both hands. Accordingly, for example, in a military situation, armed personnel must first stow their weapons before leaving the helicopter which thus renders them unable to readily defend themselves from attack while descending from the helicopter.

It is therefore a general object of the present invention to overcome, or at least ameliorate, one or more of the above mentioned disadvantages.

According to a first aspect of the present invention, there is provided a lifting and descent device which includes:
a hollow body member defining an enclosed coiled path adapted to receive a descent rope for friction retarded passage therethrough, said body member when deployed having an upper end and a lower end; and
a securing means for securing said body member to a user of said device;
characterized in that said device is adapted to enable said friction to be varied as required by providing or adjusting one or more of the following:
   at least one adjustable chuck attached to said device;
   length of said coiled path;
   diameter of said coiled path;
   internal size of said coiled path;
   diameter of said descent rope; and
   angle of inlet end and angle of outlet end, either singularly or in combination, of said coiled path.

The descent device is of similar general construction to the decent apparatus disclosed in AU653576, the entire contents of which are hereby incorporated by such reference, For example, preferably, the descent rope or similar may be selected from ropes of natural or synthetic fibre, wire ropes or the like. Similarly, preferably, the body member can comprise a coiled tubular body of polymeric, stainless or other steel, copper or any other suitable plastic or metal material.

However, the descent apparatus can be modified, in accordance with the present invention, by adjusting one or more features as described in more detail below:
by fitting at least one adjustable chuck (similar in concept to the chuck of an electric drill) to said device, said descent rope can pass through said chuck and, by adjusting the grip of said chuck on said rope, the rate of descent can be controlled;
by increasing the overall length of said body member, for example, by increasing, the number of coils that constitute said coiled path, said friction can be increased:
by decreasing the diameter of said coiled path, said friction can be increased;
by selecting the appropriate diameters for the internal diameter of said coiled path and the diameter of said descent rope, said friction can be adjusted; the closer the diameter of said descent rope is to the internal diameter of said coiled path, the greater said friction; it will be appreciated that, for a given required frictional force, this can be achieved by reducing the internal diameter of said coiled path or by increasing the diameter of said descent rope or by a combination thereof;
by adjusting said angle of inlet end and angle of outlet end, either singularly or in combination, of said coiled path, said friction can be adjusted; the more the angle moves away from vertical when the device is deployed, the greater the friction.

As a first optional feature of the present invention, said device can be further modified to enable its re-use in either direction.

To enable said device to be refused in either direction, preferably, two of said adjustable chuck are fitted one either side of said body member. When said device is to be deployed one of said chuck is in the fully open position and thus not creating any friction retardation in the travel of said descent rope, while the other can be adjusted to generate the required said friction. When travel is completed, the positions of the respective chucks can be reversed to allow travel of said descent rope in the opposite direction.

As a second optional feature of the present invention, said device can be further modified to enable travel to be arrested at any required position and to be resumed again when required.

To allow said device to enable travel to be arrested at any required position and to be resumed again when required, a locking clamp is positioned within reach of the user. A typical locking clamp girdles the descent rope and incorporates a reversible adjuster which frictionally engages the descent rope to halt movement of the descent rope through the body member.

This locking clamp finds especial, but not limiting, use in industry where it may be necessary for a person to be stationary periodically at various locations, eg, external window cleaning of high-rise buildings, or if a load is to be raised and subsequently passed through an upper window of a multi-storey building.

As a second aspect of the present invention, there is provided a method of lifting and/or lowering an item and/or person, said method including the steps of:
obtaining a lifting and descent device as hereinbefore described;
securing said upper end of said descent rope to a suitable attachment point;
attaching said item and/or person to said body member; and
adjusting and maintaining sufficient said friction as said item and/or person is lowered or raised by said device.

Preferred embodiments of the present invention will now be described with reference to the accompanying drawings wherein:

FIG. 1 is a side view of a device according to the present invention;

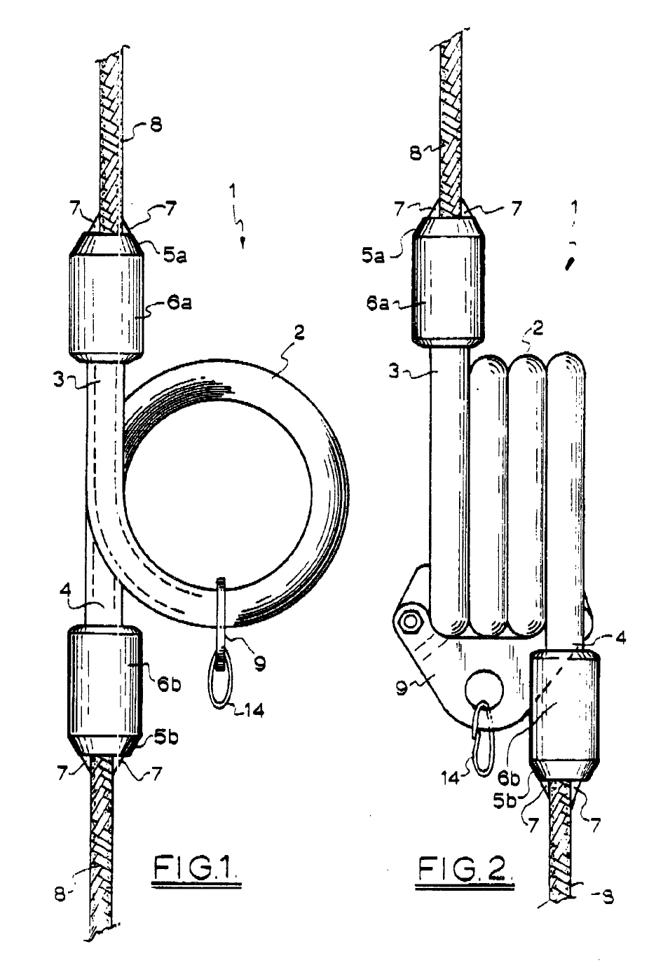

FIG. 2 is an end view of the device of FIG. 1;

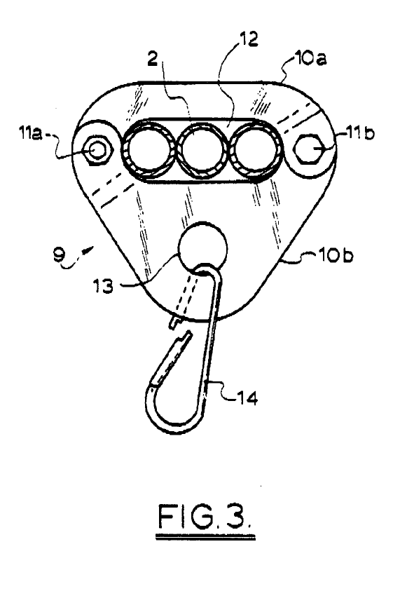

FIG. 3 illustrates a hanger plate for use with the device of FIGS. 1 and 2;

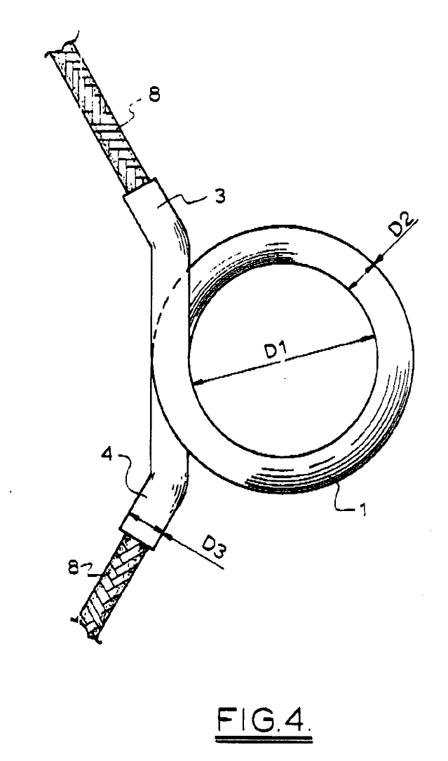

FIG. 4 illustrates possible modifications to the device of FIGS. 1 to 3; and

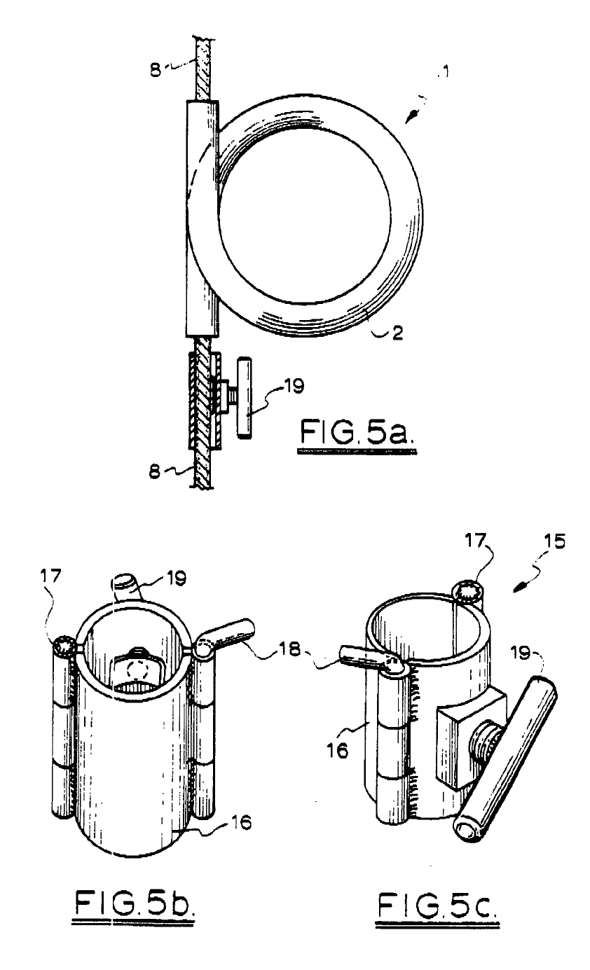

FIGS. 5a-5c illustrate an optional feature for the devices of FIGS. 1 to 4.

The decent device (1) of FIGS. 1 and 2 comprises a helical tubular body member (2) comprising three coils of copper tube typically having an internal diameter of 12 mm and a coil internal diameter of 100 mm. The outer ends of the body member (2) are configured such that they form an upper outlet end (3) and a lower outlet end (4) disposed substantially in the same vertical plane.

At each upper outlet end (3) and lower outlet end (4) is affixed a respective chuck (5a,b), each chuck (5a,b) comprising an outer internally threaded body (6a,b) which can reversibly operate respective multiple jaws (7) (not all illustrated) to bear upon a rope (8) which passes through the upper chuck (5a), the coils of the body member (2) and the lower chuck (5b).

Typically, the rope (8) is manufactured from nylon and has a diameter of 11 mm.

A hanger plate (9) (FIG. 3) comprises two shaped halves (10a,b) releasably joined together by bolts (11a,b). Each half (10a,b) is shaped such that when joined together, a slot (12) is formed of sufficient dimensions to accommodate the coils of the body member (2). The width and depth of the slot (12) are sufficient to allow the hanger plate (9) to freely move about the coils. A bore (13) is provided in the hanger plate (9) to which is attached a snap hook (14) or similar.

Prior to use, the rope (8) is threaded through the upper chuck (5a), the coils of the body member (2) and the lower chuck (5b) so that the device is configured for immediate use. The upper end of the rope (8) is either permanently made fast to a predesignated strong point or, alternatively, can quickly and easily be attached to same when required. This fixing means may comprise a simple snap hook or the like. When required for use, a user—who has donned a harness, strap, stirrup, bosun's chair or similar—is attached to the hanger plate (9) via the hook (14). The upper chuck (5a) would typically be fully closed to secure the rope (8) against initial movement while the lower chuck (5b) would be fully open to allow the rope (8) to freely pass through. The free end of the rope (8) below the chuck (5b) is draped down the descent route and the descent commenced. The user adjusts the upper chuck (5a) to control the friction applied to the rope as the gravity-assisted descent occurs, thus controlling the speed of the descent to a speed commensurate with safety. If required, additional control of the descent can be achieved by also adjusting the lower chuck (5b) to bear upon the rope (8).

In the above described embodiment, the dimensions of the device (1) essentially determine the friction that may be applicable between the interior of the coils of the body member (2) and the rope (8) when the device is in use. If it is required to have a device of differing frictional resistance, as illustrated in FIG. 4, a number of alternatives are possible—(a) the number of coils of the body member (2) can be decreased to decrease friction or increased to increase friction; (b) the diameter D1 of the body member (2) can be decreased to increase friction or increased to decrease friction; (c) the ratio of the internal diameter D2 of a coil of the body member (2) to the diameter D3 of the rope (8) can be altered; the closer the ratio moves to unity, the greater the friction; (d) the angle of the upper outlet end (3) and the lower outlet end (4), either singularly or in combination, can be adjusted; the greater the angle from vertical when the device is in use, the greater the friction.

If the device (1) of FIGS. 1 to 3 is to be used to raise and/or lower an item of goods rather than as an escape apparatus for a person, the chucks (5a,b) may not be attached to the body member (2) but positioned more closely to the upper and lower extremities of the required movement of the item. Operators positioned at each end of these extremities can then adjust the respective chucks (5a, b) as required dependent on the required movement of the item.

When the travel of the device of the present invention is to be arrested in use, as illustrated in FIGS. 5a-5c, a locking clamp (15) can be positioned within reach of the user. A typical clamp (15) (FIGS. 5b & 5c) comprises a hollow tube (16), hinged (17) longitudinally to allow the tube (16) to be placed around the descent rope (8) (FIG. 5a). A removable pin (18) secures the tube (16) in position around the rope (8). A threaded screw-type adjuster (19) is operably connected through the wall of the tube (16) to bear upon and frictionally engage the descent rope (8) as required to stop movement of the rope (8) through the body member (2). It will be noted that the device (1) is similar to that described above with reference to FIGS. 1 to 3 except that it omits the chucks (5a,b).

The present invention thus provides a relatively simple, economic device that allows an emergency exit from burning buildings and the like, or for installation and/or removal of bulky items from the upper levels of buildings, or for rapid deployment of military and other personnel from helicopters.

It will of course be realised by persons skilled in the art that, while the above has been given by way of illustrative example of the present invention, modifications, alterations and variations can be made thereto without departing from the inventive concept as defined in the following claims.

1: A lifting and descent device which includes:
a hollow body member defining an enclosed coiled path adapted to receive a descent rope or similar for friction retarded passage therethrough, said body member when deployed having an upper end and a lower end; and
a securing means for securing said body member to a user of said device;
characterised in that said device is adapted to enable said friction to be varied as required by providing at least one adjustable chuck fitted at or near said upper end of said body member, said descent rope or similar passing through said chuck and whereby adjustment of grip of said chuck on said descent rope or similar can be reversibly altered.

2: A device as defined in claim 1 wherein, said device is adapted to enable its re-use in either direction.

3: A device as defined in claim 2 wherein, to enable said device to be re-used in either direction, two of said adjustable chuck are affixed, one either side of said body member.

4: A lifting and descent device which includes:
a hollow body member defining an enclosed coiled path adapted to receive a descent rope or similar for friction retarded passage therethrough, said body member when deployed having an upper end and a lower end; and
a securing means for securing said body member to a user of said device; characterised in that said device is adapted to enable said passage to be arrested at any required position and to be resumed again when required, wherein, to arrest said passage there is provided a locking clamp, said locking clamp including
a hollow tube, hinged longitudinally to allow said tube to girdle said descent rope;
a removable pin to secure said tube in position around said rope; and
a threaded screw-type adjuster operably connected through said tube to bear upon and frictionally engage said descent rope.

5: A device as defined in claim 1, further modified to enable said passage to be arrested at any required position and to be resumed again when required wherein, to arrest said passage there is provided a locking clamp, said locking clamp including:
a hollow tube, hinged longitudinally to allow said tube to girdle said descent rope;
a removable pin to secure said tube in position around said rope; and
a threaded screw-type adjuster operably connected through said tube to bear upon and frictionally engage said descent rope.

6: A device as defined in claim 1, wherein to enable a user of said device to be secured thereto, there is provided a hanger plate, said hanger plate including:
a slot of dimensions sufficient to accommodate the coils of said body member; and
a bore adapted to accommodate a clip or similar enabling said user to be attached to said hanger plate.

7: A device as defined in claim 1 wherein, to vary said friction about a given value, said length of said coiled path is increased to raise said friction and said length of said coiled path is decreased to lower said friction.

8: A device as defined in claim 7 wherein, said length of coiled path is increased by increasing the number of coils that comprise said body member.

9: A device as defined in claim 7 wherein, said length of coiled path is decreased by decreasing the number of coils that comprise said body member.

10: A device as defined in any claim 1 wherein, to vary said friction about a given value, the diameter of said coiled path is decreased to increase said friction and increased to lower said friction.

11: A device as defined in claim 1 wherein, to vary said friction about a given value to increase said friction, the ratio of internal diameter of said body member to the diameter of said descent rope is set closer to unity.

12: A device as defined in claim 1 wherein, to vary said friction about a given value, to decrease said friction, the ratio of internal diameter of said body member to the diameter of said descent rope is set to less than unity.

13: A device as defined in claim 1 wherein, to vary said friction, about a given value, said angle of inlet end and angle of outlet end are adjusted, either singularly or in combination, of said coiled path.

14: A device as defined in claim 13 wherein, to increase said friction, one or both of said angle of inlet end and angle of outlet end are positioned away from vertical when said device is deployed.

15: A device as defined in claim 13 wherein, to decrease said friction, one or both of said angle of inlet end and angle of outlet end are positioned closer to vertical when said device is deployed.

16: A device as defined in claim 1 wherein, said body member is a coiled tubular body manufactured from any one of a material selected from a group comprising a polymeric and metal material.

17: A device as defined in claim 16 wherein said metal material is selected from the group comprising steel, stainless steel and copper.

18: A device as defined in claim 1 wherein said descent rope or similar is manufactured from any one of a material selected from a group comprising a natural fibrous material, a synthetic fibrous material and a metal wire.

19: A method of lifting and/or lowering an item and/or person, said method including the steps of:
obtaining a lifting and descent device as defined in claim 1;
securing said upper end of said descent rope to a suitable attachment point;
attaching said item and/or person by the user to said body member; and
adjusting and maintaining sufficient said tension as said item and/or person is lowered or raised by said device.
